(19) United States
(12) Patent Application Publication
(10) Pub. No.: US 2015/0124079 A1
(43) Pub. Date: May 7, 2015

(54) IMAGE DATA FORMING APPARATUS AND CONTROL METHOD THEREOF

(71) Applicant: CANON KABUSHIKI KAISHA, Tokyo (JP)

(72) Inventor: Masanori Sato, Yokohama-shi (JP)

(21) Appl. No.: 14/527,975

(22) Filed: Oct. 30, 2014

(30) Foreign Application Priority Data
Nov. 6, 2013 (JP) 2013-230366
May 14, 2014 (JP) 2014-100828

(51) Int. Cl. G02B 21/00

(52) U.S. Cl. CPC G02B 21/008
USPC 348/80

(57) ABSTRACT

An image data-forming apparatus comprises an image data buffer unit that can temporarily store a part of pathological image data. When an image data output unit generates display image data from the pathological image data, the image data output unit uses data stored in the image data buffer unit when data required for generating display image data is stored in the image data buffer unit. The pathological image data includes data on a plurality of annotations attached to certain positions in the pathological image. A buffering control unit controls buffering based on information on the pathological diagnosis linked to each of the plurality of annotations.

### BACKGROUND OF THE INVENTION

1. Field of the Invention

The present invention relates to a technique of implementing faster change in a display area in an image viewer.

2. Description of the Related Art

In the field of pathology, a virtual slide system, which images a test sample placed on a preparation and digitizes the image to enable pathological diagnosis on a display, is used instead of an optical microscope, which is a conventional pathological diagnostic tool. By digitizing the pathological diagnosis using the virtual slide system, a conventional image of a test sample captured by an optical microscope can be handled as digital data. Thereby improved convenience can be expected in terms of explanations to a patient by using digital images, sharing rare cases, quickening remote diagnosis, and making education and training efficient.

An image viewer, to visualize the image data digitized by a virtual slide system, becomes an interface which directly connects the system and a pathologist (user), hence ease of use of the image viewer has a major influence on operability of the system itself.

Operability of a conventional image viewer however is sometimes inferior to that of a microscope. For example, a size of pathological image data is normally huge, and is several times to several hundred times the size of the area displayed on screen, depending on the case. If such huge image data is displayed on the image viewer, and the display data is updated by inputting an instruction by scrolling, for example, the response of the screen display to the input delays in some cases. This response delay often irritates the user of the image viewer, and could be a reason for dampening the popularity of a virtual slide system. Therefore improving the display responsiveness of the image viewer eliminates one barrier for a pathologist to use the virtual slide system, and this is very important.

Improving the display responsiveness of the image viewer is not a problem limited to the virtual slide system, but is a problem that is widely recognized. To solve this problem, the image data volume that exceeds the screen display area is normally stored in advance in a buffer memory of which access speed is relatively fast, and when a screen is updated by scrolling or the like, the next display data is read from the buffer memory. Herein below, the processing to read the image data or a part of the image data in advance from a buffer area, of which access speed is fast, in order to improve the responsiveness of the screen display, is called “buffering”. This processing is also called “caching”, and the memory used for cashing may be called a “cache memory” or a “cache”. In this description, the terms buffer and cache have the same meaning.

Buffering is a well known processing method, but in standard buffering, an area larger than the screen display area is read for equal amounts in the vertical and horizontal directions. In other words, in this case an area that is actually displayed on screen is located at the center of the image data area which was read from the buffer memory. This method is effective when using vertical and horizontal scrolling to change an image displayed on screen. However the responsiveness of the image viewer may drop if the scrolling amount at one event is large. This is because the area to be displayed on screen next moves outside the buffered area, therefore the image data must be read from a storage device which is slower than the buffer memory. To prevent this state, more buffer capacity should be secured, but this does not mean that the utilization efficiency of the buffer memory improves, and most buffered data ends up being wasted. In other words, generally speaking it is necessary to use as much buffer memory space as possible, in order to improve the display responsiveness of the image viewer.

The essential cause of these problems is because the next display image cannot be accurately predicted. In other words, if the next display image can be predicted at high probability, then the utilization efficiency of the buffered data could be improved.

In Japanese Patent Application Laid-open No. 2006-113801, for example, if text data is included in the image data, the content of the image is analyzed first using the characteristic that the text is read in a specific direction, then data to be buffered is selected. Thereby the technique disclosed in Japanese Patent Application Laid-open No. 2006-113801 implements both a faster scrolling display and a more efficient use of memory.

### SUMMARY OF THE INVENTION

In the state disclosed in Japanese Patent Application Laid-open No. 2006-113801, the reading direction of the text is predetermined, therefore buffering that utilizes this characteristic is effective. However in the case of an image (e.g. pathological image) that does not include semantic data, such as text, the direction thereof cannot be uniquely determined by the characteristic of the image, hence there is no method for controlling buffering to implement both a faster speed and a more efficient use of memory. Furthermore, in the case of Japanese Patent Application Laid-open No. 2006-113801, the technique is effective to display an area adjacent to the current display image by scrolling, but responsiveness drops when an image located at a position distant from the current display image is displayed.

With the foregoing in view, it is an object of the present invention to provide a technique to improve the display responsiveness and the utilization efficiency of the buffer memory in pathological diagnosis.

A first aspect of the present invention resides in an image data-forming apparatus that generates display image data from pathological image data, the display image data being generated for a viewer having a function of displaying a part of a pathological image and changing the display target part according to an operation by a user,

the image data-forming apparatus comprises:

an image data buffer unit that can temporarily store a part of the pathological image data;

an image data output unit that generates display image data from the pathological image data, and that uses data stored in the image data buffer unit when data required for generating the display image data is stored in the image data buffer unit; and

a buffering control unit that implements control of storing data on a part of the pathological image in the image data buffer unit, wherein

the pathological image data includes data on a plurality of annotations attached to certain positions in the pathological image, and

the buffering control unit controls buffering based on information on the pathological diagnosis linked to each of the plurality of annotations.

A second aspect of the present invention resides in an image data-forming method comprising:

an image data buffer step of temporarily storing a part of the pathological image data in an image data buffer unit;

an image data output step of generating display image data from the pathological image data for a viewer having a function of displaying a part of the pathological image and changing the display target part according to an operation by the user, and using the data stored in the image data buffer unit when the data required for generating the display image data is stored in the image data buffer unit;

a step of acquiring data on a plurality of annotations, included in the pathological image data and attached to certain positions in the pathological image; and

a step of implementing control of storing a part of the pathological image in the image data buffer unit based on the information on the pathological diagnosis linked to each of the plurality of annotations.

A third aspect of the present invention resides in a non-transitory computer readable storage medium storing a program that causes an image data-forming apparatus to be executing:

an image data buffer step of temporarily storing a part of the pathological image data in an image data buffer unit;

an image data output step of generating display image data from the pathological image data for a viewer having a function of displaying a part of the pathological image and changing the display target part according to an operation by the user, and using the data stored in the image data buffer unit when the data required for generating the display image data is stored in the image data buffer unit;

a step of acquiring data on a plurality of annotations, included in the pathological image data and attached to certain positions in the pathological image; and

a step of implementing control of storing a part of the pathological image in the image data buffer unit based on the information on the pathological diagnosis linked to each of the plurality of annotations.

According to this invention, the display responsiveness and the utilization efficiency of the buffer memory can be improved in pathological diagnosis.

Further features of the present invention will become apparent from the following description of exemplary embodiments with reference to the attached drawings.

### BRIEF DESCRIPTION OF THE DRAWINGS

FIG. 1 is a system block diagram depicting an image processing system according to Embodiment 1;

FIG. 2 is a hardware block diagram depicting an image-forming apparatus according to Embodiment 1;

FIG. 3 is a functional block diagram depicting the image-forming apparatus according to Embodiment 1;

FIG. 4 is a general view of pathological image data;

FIG. 5 is a diagram depicting a relationship between the image data included in pathological data, each area, and annotations;

FIG. 6 is a flow chart depicting an overview of a flow of the image-forming processing according to Embodiment 1;

FIG. 7 is a flow chart depicting a flow of the initial setting processing according to Embodiment 1;

FIG. 8 is a flow chart depicting a flow of the buffer content update processing according to Embodiment 1;

FIG. 9 is a schematic diagram depicting a buffering priority of each area according to Embodiment 1;

FIG. 10 is a schematic diagram depicting an example of buffering according to Embodiment 1;

FIG. 11 is a schematic diagram depicting a buffering priority of each area according to Embodiment 2;

FIG. 12 is a schematic diagram depicting an example of buffering according to Embodiment 2;

FIG. 13 is a schematic diagram depicting a buffering priority of each area according to Embodiment 3;

FIG. 14 is a schematic diagram depicting an example of buffering according to Embodiment 3; and

FIG. 15 is a diagram depicting another configuration example of the image processing system.

### DESCRIPTION OF THE EMBODIMENTS

The present invention relates to a technique for improving the display responsiveness upon moving the display area in an image viewer that has a function to display an image corresponding to a part of original image data, and to change (e.g. scrolling, jumping) the display portion according to the operation by the user. In concrete terms, according to the present invention, data to be buffered is appropriately controlled in an apparatus that generates image data for display (display image data) from the original image data, thereby the utilization efficiency of the buffer memory is improved and as a result, the display responsiveness is comprehensively improved.

More particularly according to the present invention, original image data is handled as a block image data group, buffering priority is determined for each block image data, and a block image data having the highest priority is buffered preferentially. This buffering priority should be determined based on the result of analyzing information of annotations attached to the image. Here “annotation” refers to a marker that is attached to an individual position (point or area) in the image. Some information on pathological diagnosis can be linked to a specific annotation. (Information linked to an annotation is called “annotation information”.) Any type of information may be included in annotation information. Typically information on date when the annotation is created, creator, type of annotation, importance (state of lesion and stage of disease), diagnostic remarks and other comments, for example, can be included. If an annotation is created by automatic diagnostic software or the like, diagnostic information created by such software and information that identifies the software may be included in the annotation information. In this description, various information other than comment information is called “attribute information”. Depending on the context, a marker and annotation in toto may be called an “annotation”.

In a virtual slide system which will be described in the following embodiment, important information, such as remarks based on pathological diagnosis, is written as a comment in an annotation (in this description, the remarks based on the pathological diagnosis and related attribute information are collectively called “pathological diagnostic information”). Therefore if an annotation is included in an image, it is more likely that the image around the annotation is viewed by an image viewer, compared with other portions of the image. Hence if an image around the annotation is buffered in advance, the display responsiveness can be improved when the user requests to display a peripheral area thereof. This effect is conspicuous when the display request is for an area distant from the currently displaying area, which cannot be displayed immediately by scrolling alone. In other words, position information of the annotation is utilized for predicting data to be buffered. Further, if only annotations that satisfy a certain condition are targeted for buffering, then buffering with good memory utilization efficiency can be implemented even when a number of annotations is large or when a capacity of the buffer memory is limited.

### Embodiment 1

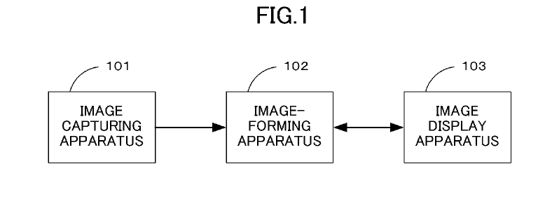

The image processing system according to Embodiment 1 will be described with reference to the drawings. The method shown in this embodiment is implemented under the system configuration depicted in FIG. 1. 101 is an image-capturing apparatus, which primarily corresponds to an image capturing portion in a virtual slide system. The image-capturing apparatus 101 is an apparatus that images a slide (preparation) of a pathological sample as an object at a high magnification and high resolution, and acquires digital image data, and is also called a “digital microscope”. 102 is an image-forming apparatus, and is a major component to implement the method shown in this embodiment. In concrete terms, the image-forming apparatus 102 receives image data generated by the image-capturing apparatus 101, and generates display image data. 103 is an image display apparatus, and displays an image on the screen based on the display image data received from the image-forming apparatus 102.

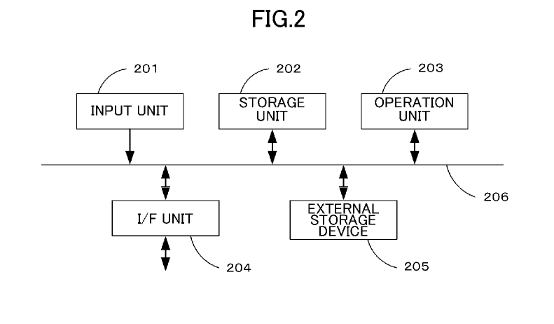

In this embodiment, the image-forming apparatus 102 can be implemented by, for example, a computer having the hardware configuration shown in FIG. 2, and programs that provide various later mentioned functions. 201 is an input unit which corresponds to a keyboard, a mouse or the like. 202 is a storage unit that stores programs, required for implementing the method shown in this embodiment, and processing data, and corresponds to RAM or the like. 203 is an operation unit that performs various processing operations on the data stored in the storage unit 202, according to the programs stored in the storage unit 202, and corresponds to a CPU or the like. 204 is an I/F unit, and is an interface component to control the data input/output to/from the image-capturing apparatus 101 and the image display apparatus 103. 205 is an auxiliary storage device (or external storage device), and corresponds to a hard disk, flash memory or the like. 206 is a data bus that connects 201 to 205.

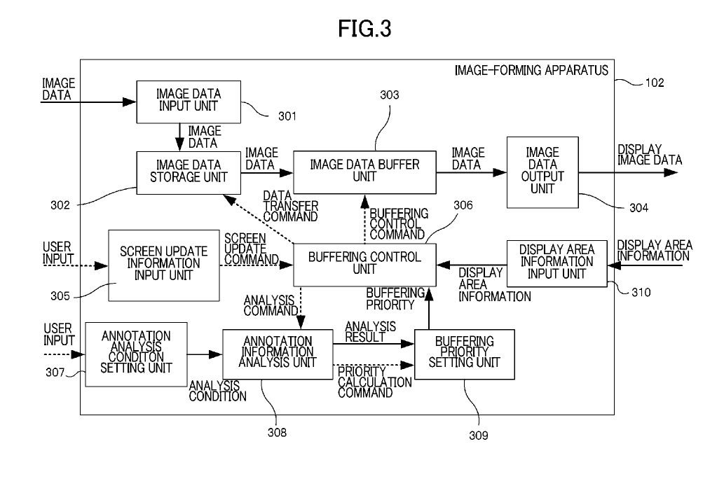

FIG. 3 is a functional block diagram of the image-forming apparatus 102 according to this embodiment. 301 is a image data input unit, and is a component to which image data is inputted from the image capturing apparatus 101. 302 is an image data storage unit, and is a storage device to store image data inputted from the image data input unit 301. 303 is an image data buffer unit, which can receive a buffering control command, in order to receive a part of the image data from the image data storage unit 302, and temporarily stores the data. The image data buffer unit 303 also transmits image data required for generating the display image data to an image data output unit 304. The image data storage unit 302, which must store the entire image data, is constituted by a storage device having a large storage capacity (e.g. external storage device 205 in FIG. 2). The image data buffer unit 303, on the other hand, is a storage device that functions as a buffer memory for the image data, and is constituted by a device that can read/write data at high-speed, compared with the image data storage unit 302. In this embodiment, the image data buffer unit 303 is set in the storage unit 202, but a dedicated buffer memory may be installed independently from the storage unit 202. The capacity of the image data buffer unit 303 is smaller than the image data storage unit 302, and cannot comprehensively store image data. In the following description, the image data buffer unit 303 may be called a “buffer memory” or simply a “buffer”. To input the image data, the image data input unit 301 may receive a data transfer command from a buffering control unit 306, and directly transfer the image data from the image-capturing apparatus 101 to the image data buffer unit 303, without passing through the image data storage unit 302.

304 is an image data output unit which generates display image data, using the image data received from the image data storage unit 302 or the image data buffer unit 303, to be outputted to the image display apparatus 103. 305 is a screen update information input unit, which accepts input by the user via an input device such as a mouse, and transmits a screen update command to the buffering control unit 306 based on this input. The buffering control unit 306 has a function to control data to be stored in the image data buffer unit 303. The buffering control unit 306 transmits a data transfer command to the image data storage unit 302, or receives display area information from a display area information input unit 310, and transmits a buffering control command to the image data buffer unit 303 based on this information. Further, the buffering control unit 306 transmits a command to analyze the annotation information, attached to the image data, to an annotation information analysis unit 308, and receives buffering priority information from a buffering priority setting unit 309.

307 is an annotation analysis condition setting unit, which generates an analysis condition required for annotation information analysis based on the user input, for example, and transmits the analysis condition to the annotation information analysis unit 308. Instead of user input, the annotation analysis condition setting unit 307 may generate the analysis condition using other information held in the image-forming apparatus 102, such as organ information attached to the image and viewer information of the image.

The annotation information analysis unit 308 analyzes the annotation information by the analysis command received from the buffering control unit 306, and transmits this result to the buffering priority setting unit 309. The annotation information analysis unit 308 also transmits a priority calculation command to the buffering priority setting unit 309. The buffering priority setting unit 309 calculates the buffering priority based on this information, and transmits the result to the buffering control unit 306. A display area information input unit 310 acquires display area information held by an OS or the like, and transmits the result to the buffering control unit 306.

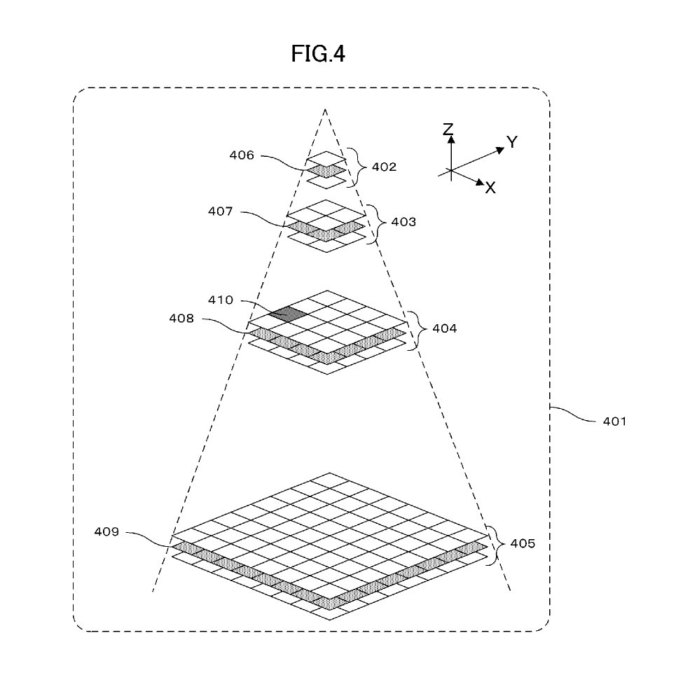

FIG. 4 is a general view depicting a structure of pathological image data. In this embodiment, image data having the structure illustrated in FIG. 4 is handled. In the pathological image data 401, images of an object (pathological sample) captured by the image-capturing apparatus 101 are stored. The pathological image data 401 is constituted by depth image groups 402 to 405 of which display magnifications of the object are different from one another. In this embodiment, 402 to 405 are depth image groups of which display magnifications are equivalent to ×2.5, ×5, ×10 and ×20 respectively. This phase “equivalent to xoo” refers to the size of an object recorded in a corresponding image that is approximately the same as the size observed by an optical microscope which uses an objective lens, of which magnification is xoo. Each depth image group 402 to 405 is constituted by a plurality of image data captured at different depths. “Depth” here refers to the focal position (depth) of the image-capturing apparatus 101 in the optical axis direction. For example, the image data 406 to 409 were all captured at a same depth, although display magnifications thereof are mutually different.

All image data constituting the pathological image data 401 is constituted by each block image data 410 as the minimum unit. In this embodiment, such processing as data transfer is executed in the units of this block image data 410. Each block image data 410 may be an independent image file, or image data 406 to 409 may be independent image files, and the block image data 410 may be defined as a unit to handle these [independent image files] internally. All block image data can be uniquely specifies using an index (i, j, k, l) constituted by a plurality of integers. Here i denotes an index in the x axis direction, j denotes an index in the y axis direction, k denotes an index in the z axis (depth) direction, and l denotes an index in the magnification direction. When there are two block image data of which the i and j match with each other, these are block image data at a same position on the xy plane if the respective l indices match. All l indices of the block image data belonging to a same depth image group have a same value.

The pathological image data shown in FIG. 4 can be generated by photographing one object (pathological sample) by the image-capturing apparatus 101 for a plurality of times, while changing the magnification and the focal position in the optical axis direction. Various data on the object or image group can be attached to the pathological image data. The above mentioned annotation is one such example. The annotation data includes at least the position information of the annotation (marker) and annotation information linked to the annotation. The position information of the annotation can be defined by the combination of an index to specify the block image data and the xy coordinates in the block image data. To attach an annotation on an area having a certain scale of expansion and not a point, the coordinates of two points which are at positions diagonal to each other of a rectangular area, or the center coordinates and radius of a circular area, for example, can be used as the position information of the annotation. If a plurality of annotations are attached to one pathological image data, annotation data is created for each annotation. Examples of the annotation data will be described later.

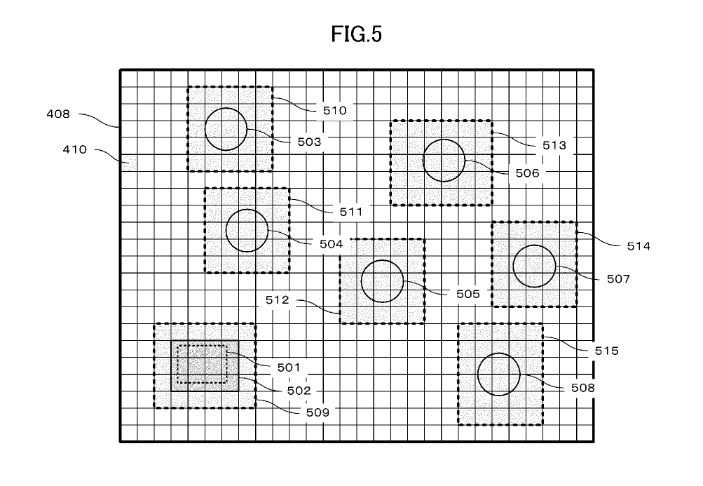

FIG. 5 shows how to handle image data according to this embodiment. In FIG. 5, image data 408, out of pathological image data 401, is the display target on screen. 501 is an area where the screen display is actually performed by the image display apparatus. Hereafter 501 is referred to as the “screen display area”. 502 is an image area to transfer image data to the image display apparatus 103 for displaying the data on the screen, and hereafter 502 is referred to as the “display data area”. In this embodiment, the display data area 502 is defined as an area that is constituted by the minimum block image data 410 required to completely contain the screen display area 501. In some cases however, an area larger than this definition may be defined as the display data area 502. The screen display area 501 and the display data area 502 may be matched.

503 to 508 are annotations linked to an image. Each annotation is a circular graphic, and the size thereof is larger than the block image data 410. In come cases however, the graphic to express an annotation may have a shape other than a circle, and the size thereof may be smaller than the block image data 410. Annotation data corresponding to the annotations 503 to 508 is attached to the pathological image data 401 that includes the image data 408. The annotation data of this embodiment is constituted by an ID number, creator name, creation date, individual who updated the data last, date of last update and comment, for example. Table 1 shows an example of the annotation data.

TABLE 1

| | | | Person who | | |
|---|---|---|---|---|---|
| | | | updated data | Date of last | |
| ID | Creator | Creation date | last | update | Comment |
| 1 | Takeshita | 2012 Feb. 26 | Manabe | 2012 Dec. 12 | ◯◯◯ • • • |
| 2 | Kimura | 2012 Apr. 1 | Takeshita | 2013 Jan. 13 | XXX • • • |
| 3 | Kano | 2012 Apr. 7 | Niinabe | 2013 Jan. 13 | ΔΔΔ • • • |
| 4 | Sakota | 2012 Aug. 29 | Sakota | 2012 Aug. 29 | □□□ • • • |
| 5 | Sakota | 2012 Aug. 29 | Sakota | 2012 Aug. 29 | ⋄⋄⋄ • • • |
| 6 | Kano | 2012 Oct. 5 | Kano | 2012 Oct. 5 | ∇∇∇ • • • |

In this embodiment, the annotations 503 to 508 correspond to the IDs 1 to 6 of the annotation data respectively.

509 to 515 are the target areas to be buffered, and the size of each area (the amount of margin provided when the area is buffered) can be specified or changed in advance by the user or by a program. Hereafter 509 to 515 are referred to as the “buffering target area” respectively. There are two types of buffering target areas: a first buffering target area 509 linked to the screen display area 501, and second buffering target areas 510 to 515 related to positions where annotations are attached.

In this embodiment, the first buffering target area 509 is defined as an area that is wider than the display data area 502 by one block image data area in vertical and horizontal directions respectively, and excludes the display data area 502. In other words, the first buffering target area 509 is a group of one row of block image data around the display data area 502. If necessary however, the display data area 502 may be included in the buffering target area 509. In this embodiment, the second buffering target areas 510 to 515 are defined as areas that are larger than the minimum area, required to completely contain the corresponding annotations 503 to 508, by one block image data area respectively in the vertical and horizontal directions.

The definition range of the buffering target area is not limited to the above example, but may be changed if necessary. For example, in FIG. 5, a margin of the buffer is one row around (in the vertical and horizontal directions) the display data area 502 or the annotation area, but two or more rows of blocks around these areas may be included in the buffer target area. The width (number of rows of the blocks) of the margin may be different at the top, bottom, left and right respectively. For example, if it is known in advance that scrolling in the horizontal direction (x direction) will be more frequently used than in the vertical direction (y direction), one row in the vertical direction and two rows in the horizontal direction may be set for the buffering target area.

In FIG. 5, the buffer target block image data is selected from image data (image data 408) of which depth is the same as the display image of the image viewer, but the buffering target area may be expanded in the depth direction, for example. In other words, not only data on the annotation portion in the image data 408 of which depth is the same as the display image, but also data on a corresponding portion in the image data of which depth is different from the display image is selected as the target for buffering. For example, when the index of the block image data of an annotation portion is (i, j, k, l), the block image data of which index is (i, j, k+p, l) is included in the buffering target area. This type of buffering is effective when the image viewer has a function to change the display image in the depth direction (depth scrolling). p is an integer other than 0. Further, the buffering target area may be expanded in the magnification direction. In other words, not only data in the annotation portion in the image data 408 of which magnification is the same as the display image, but also data of the corresponding portion in image data of which magnification is different from the display image is also selected as a buffering target. For example, when the index of the block image data of an annotation portion is (i, j, k, l), the block image data of which index is (i′, j′, k, l+q) is included in the buffering target area. This type of buffering is effective when the image viewer has a function to switch display magnification. q is an integer other than 0. i and i′ and j and j′ are mutually different values in most cases. The buffering target area may be expanded in the depth direction and in the magnification direction simultaneously.

(Image-Forming Processing)

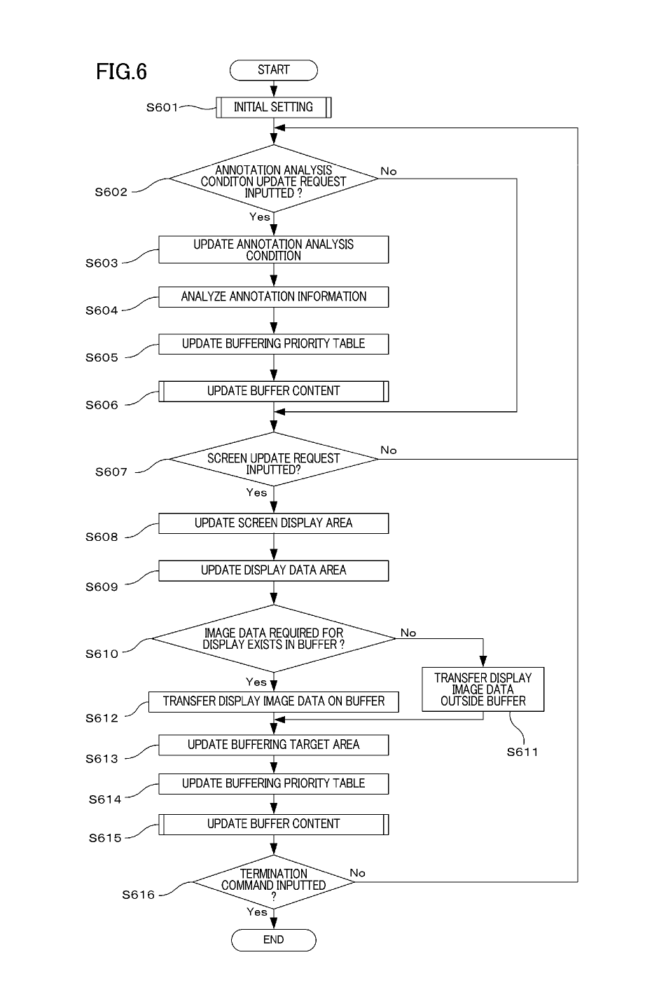

FIG. 6 is a flow chart depicting an overview of the flow of image-forming processing according to this embodiment. The processing flow will now be described with reference to FIG. 6.

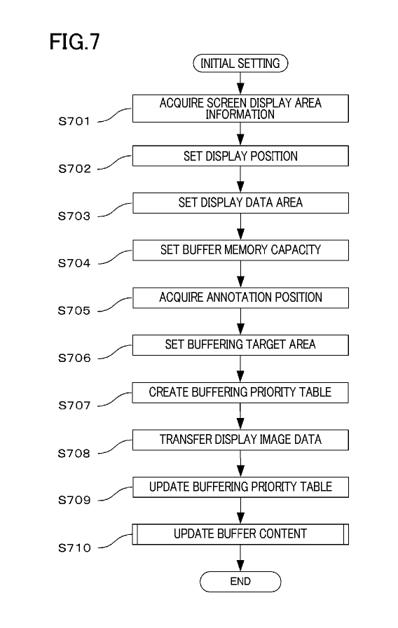

First the buffering control unit 306 performs the initial setting (step S601). In step S601, the processing shown in FIG. 7 is executed. A detailed processing flow of the initial setting will be described later.

After step S601, the annotation analysis condition setting unit 307 determines whether an annotation analysis condition update request was inputted to the image-forming apparatus 102 by user input or the like (condition determination step S602). The annotation analysis condition update request is an operation to change the condition which determines the focus of information (priority) included in the annotation information. For example, information that is focused on (e.g. creator of the annotation, date or date and time of creation, date or date and time of update, keyword included in a comment) and the condition to determine priority should be provided as an annotation analysis condition. In concrete terms, various specification methods can be used, such as increasing the priority of an annotation created by a creator “Dr. oo”, increasing the priority of an annotation of which date and time of creation are newer, and increasing the priority of an annotation in which a specific keyword in the comment is included. In the case of user input, the analysis condition input screen is displayed on the image display apparatus, for example, and information to be focused on and a condition to determine the priority are selected or inputted by the user by using such an input device as a mouse. The annotation analysis condition setting unit 307 may automatically set the analysis condition. For example, information attached to pathological image data (e.g. sample dyeing method, type of organ) is extracted, and keywords corresponding to the information are set as an analysis condition.

If it is determined that the annotation analysis condition update request was inputted in the condition determination step S602, the annotation analysis condition setting unit 307 updates the annotation analysis condition based on this input (step S603). In concrete terms, data of the annotation analysis condition stored in the storage unit 202 is updated. If the result of the condition determination step S602 is NO, then processing advances to step S607.

Then the annotation information analysis unit 308 analyzes the annotation information according to the annotation analysis condition (step S604). In other words, the annotation information analysis unit 308 searches the annotation information of all the annotations included in the pathological image data, and extracts annotations that match with the analysis condition. A specific analysis procedure and analysis result thereof could be different depending on the content of the provided analysis condition. For example, if the analysis condition is a condition that specifies the “creator of the annotation”, then only those annotations created by the specified creator are selected from all the annotations. If the analysis condition is “last update data that is most recent”, then all the annotations are rearranged (sorted) in the sequence of the last update that is most recent. If the analysis condition is a keyword in a comment, only annotations that include the keyword are selected, or annotations may be sorted in the sequence of a higher matching degree with the keyword. The analysis result of the annotation information analysis unit 308 (e.g. list of ID numbers of the extracted an sorted annotations) is transferred to the buffering priority setting unit 309.

Then the buffering priority setting unit 309 determines the buffering target area based on the analysis result in step S604. In other words, the buffering target areas 510 to 515 are set so as to include each annotation portion with reference to the position information of the annotations extracted in step S604. Then the buffering priority setting unit 309 determines the buffering priority of each block image data that exists in the buffering target areas 510 to 515, and updates the content of the current buffering priority table (step S605). The buffering priority table is a table that is created in step S707 in the initial setting step S601. Step S707 will be described later.

The buffering priority table is a table constituted by an ID number of each block image data in the buffering target area, an ID number of the corresponding buffering target area, and a buffering priority thereof. The ID number of each block image data corresponds one-to-one with an index number that uniquely specifies each block image data. In this embodiment, the ID number of the buffering target area 509 is “0”, and the ID numbers of the buffering target areas 510 to 515 match with the ID numbers of the annotations to which these buffering target areas belong (in other words, integers 1 to 6 are assigned sequentially). In this embodiment, the value of the buffering priority is a positive integer, and the greater the value the higher the priority, but if necessary priority assignment that is different from this definition may be used for the values of the buffering priority, such as using positive or negative real numbers. Table 2 shows an example of a buffering priority table.

TABLE 2

| Block image data ID | Buffering target area ID | Buffering priority |
|---|---|---|
| 37 | 0 | 9 |
| 38 | 0 | 9 |
| 39 | 0 | 9 |
| [symbol] | [symbol] | [symbol] |
| 123 | 1 | 0 |
| 124 | 1 | 0 |
| [symbol] | [symbol] | [symbol] |
| 376 | 3 | 1 |
| 377 | 3 | 1 |
| [symbol] | [symbol] | [symbol] |

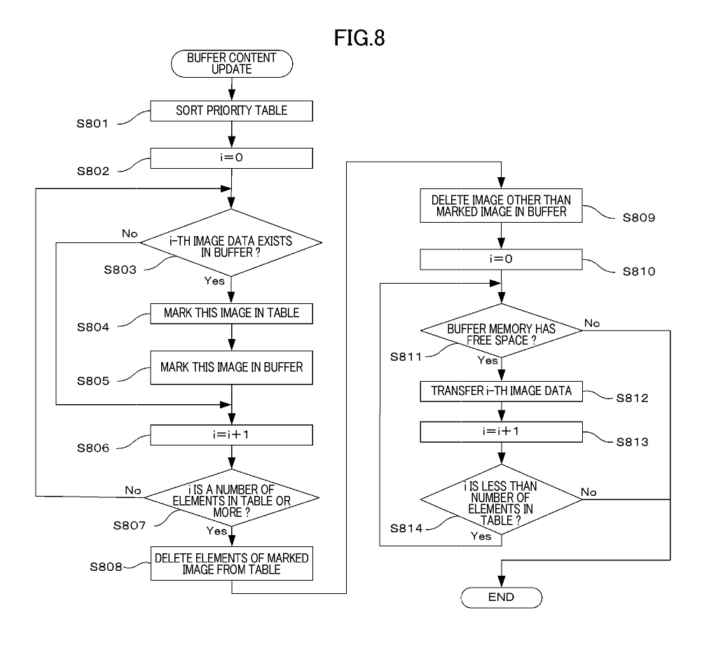

Then based on the content of the buffering priority table updated in step S605, the buffering control unit 306 updates the data stored in the image data buffer unit 303 (this is called the “buffer content”) (step S606). If it is unnecessary to update the buffer content, such as the case when the result, based on the updated analysis condition, matches with the result based on the analysis condition before update, the processing in step S606 may be omitted to ensure efficient processing. There are some methods that can be used for the processing in step S606, and FIG. 8 shows an example. Detailed content of FIG. 8 will be described later.

After step S606, the buffering control unit 306 determines whether a screen update request was inputted, in use of a certain means, to the image-forming apparatus 102 (condition determination step S607). The screen update request is, for example, a screen scroll instruction or a screen switching instruction inputted from such an input device as a mouse. If no screen update request is inputted, processing returns to step S602.

When it is determined that the screen update request was inputted in step S607, the buffering control unit 306 updates the screen display area information based on this input (step S608). Here “screen display area information” refers to the information on the position and display area of the screen display area 501 based on the image data 408.

Then the buffering control unit 306 updates the display data area information based on the updated screen display area information (step S609). Here “display data area information” refers to the position and area of the display data area 502 based on the image data 408.

Then the buffering control unit 306 determines whether the block image data required for screen display exists in the image data buffer unit 303 (condition determination step S610). If the determination result of the condition determination step S610 is “YES”, then processing advances to step S612, where the image data output unit 304 reads the block image display inside the image data buffer unit 303, generates the data image data, and transfers the data to the image display apparatus 103. If the determination result of the condition determination step S610 is “NO”, on the other hand, the processing advances to step S611, where the image data output unit 304 reads the block image data from the image data storage unit 302, generates the display image data, and transfers the data to the image display apparatus 103. The block image data itself may be transferred as the display image data, or the display image data may be generated by performing the necessary image processing (e.g. resolution conversion, gradation correction, color correction, enhancement processing, combining processing, format conversion) on the block image data.

Then the buffering control unit 306 updates the buffering target area information (step S613). Here “buffering target area information” refers to information on the position and shape of the buffering target area 509 and the buffering area range based on the image data 408. To simplify description in this embodiment, it is assumed that the positional relationship between the display data area 502 and the buffering target area 509, and the shape of the buffering target area 509 do not change. However if the position of the buffering target area 509 changes, it is possible that the buffering target area 509 and any of the buffering target areas 510 to 515 may overlap.

Then the buffering priority setting unit 309 updates the content of the current buffering priority table (step S614). If the buffering target area 509 does not overlap with any buffering target area 510 to 515, a predetermined priority is set for the block image data belonging to the buffering target area 509. For example, a higher priority is always assigned to block image data belonging to the buffering target area 509 rather than to other block image data. This method is based on the assumption that when the screen display area 501 moves, it is more likely to be moved by scrolling in the vertical or horizontal direction, rather than by jumping to a distant area. If the buffering target area 509 overlaps with any of the buffering target areas 510 to 515, priority is set regarding that the block image data existing in the overlapped area belongs to the buffering target area 509.

Then the buffering control unit 306 updates the buffer content stored in the image data buffer unit 303 based on the content of the buffering priority table updated in step S614 (step S615). According to the algorithm described in FIG. 6, the buffer content is always updated if a screen update request is inputted, but if it is unnecessary to update the buffer content, such as the case when the scrolling amount is small, the processing in step S615 may be omitted within an appropriate range, to ensure efficient processing. The specific processing in step S615 is the same as step S606, and will be described later with reference to FIG. 8.

After step S615, the buffering control unit 306 checks whether a command to terminate the program was inputted (condition determination step S616). If the result of the condition determination step S616 is “YES”, the program is terminated, and if “NO”, then processing continues returning to the condition determination step S602.

The above description is an overview of the flow of the image-forming processing according to this embodiment.

(Initial Setting Step S601)

FIG. 7 is a flow chart depicting a detailed flow of the initial setting step S601 according to this embodiment. The initial setting step S601 will be described with reference to FIG. 7.

First the buffering control unit 306 acquires the screen display area information from the display area information input unit 310 (step S701). This information is information on the display screen resolution.

Then the buffering control unit 306 sets a position of the screen display area based on the image data 408 on the depth and magnification to be displayed (step S702). By the information on the display screen resolution acquired in step S701 and information on the position which is set in step S702, the position and area of the screen display area in the image data 408 are determined. The depth, magnification and area of the initial display can be set, for example, based on an area at the center of the image data 408 of which depth and magnification are intermediate values in the pathological image data 401.

Then the buffering control unit 306 sets the display data area in the screen display area determined in step S702 (step S703). In step S703, the position and area of the display data area are determined.

Then the buffering control unit 306 sets the buffer memory capacity (step S704). The buffer memory capacity is set by the user or the program according to the capacity of the storage unit 202 included in the image-forming apparatus.

Then the positions of the annotations 503 to 508 linked to the image data 408 are acquired (step S705). This corresponds to acquiring the annotation data attached to the pathological image data 401 and acquiring the center positions and radiuses of the annotations 503 to 508 in the image data 408.

Then the position, area and shape of each buffering target area 509 to 515 are set (step S706). This setting is as described above.

Then the buffering control unit 306 creates the buffering priority table to store the buffering priority of each block image data existing in the buffering target areas 509 to 515 (step S707). As described instep S605, the buffering priority table is a table constituted by an ID number of each block image data in the buffering target areas 509 to 515, an ID number of the corresponding buffering target area, and a buffering priority thereof. At this point, the value of the buffering priority has not yet been calculated, therefore an appropriate value, such as “0”, is set.

Then under control of the buffering control unit 306, the image data output unit 304 reads the block image data of an area corresponding to the display data area 502 from the image data storage unit 302, and transfers this data to the image display apparatus 103 (step S708).

Then based on the information on the display data area 502 transferred to the image display apparatus 103, the buffering priority setting unit 309 updates the buffering priority table (step S709). In step S709, a predetermined priority is set to only those elements corresponding to the block image data belonging to the buffering target area 509 (that is, only block image data around the area displayed in step S708) in each element of the buffering priority table. The processing in step S709 is the same as in step S614.

Then the buffering control unit 306 updates the content of the buffer based on the buffering priority which was set in step S709 (step S710). The processing in step S710 is the same as in step S606 or S615.

The initial setting processing S601 then ends.

(Buffer Content Update Step S606, S615 and S710)

FIG. 8 is a flow chart depicting an example of a detailed flow of the buffer content update processing steps S606, S615 and S710 according to this embodiment. This processing will now be described with reference to FIG. 8.

First the buffering control unit 306 sorts all the elements of the buffering priority table (hereafter called “priority table”) in the sequence of higher priority (step S801).

Then the buffering control unit 306 provides an integer type variable i, and sets variable i to “0” (step S802).

The buffering control unit 306 checks whether the block image data corresponding to the i-th element in the priority table already exists in the buffer (condition determination step S803). For example, a list of ID numbers corresponding to the block image data existing in the buffer is created in advance, and the ID number corresponding to the i-th block image data is collated with the list of the image in the buffer. If the result of the condition determination step S803 is “YES”, the buffering control unit 306 attaches a mark to the i-th element in the priority table (step S804), and also attaches a mark to the block image data detected in the buffer (step S805). It is preferable that a certain flag corresponds to this mark. If the result of the condition determination step S803 is “NO”, processing advances to step S806.

In step S806, the buffering control unit 306 increases the value of the variable i by 1.

In the condition determination step S807, the buffering control unit 306 checks whether the value of the variable i is a number of the elements of the priority table or higher. If the result of the condition determination step S807 is “NO”, processing returns to the condition determination step S803. If the result of the condition determination step S807 is “YES”, the buffering control unit 306 deletes the marked elements in the priority table (step S808). As a result, only elements that indicate the block image data having high priority and that do not exist in the buffer (in other words, block image data that should be added to the buffer) remain in the priority table.

After step S808, the buffering control unit 306 deletes the block image data other than marked images in the buffer (step S809). As a result, block image data which need not be buffered is deleted, and free space is created in the buffer.

In step S810, the buffering control unit 306 substitutes “0” for the variable i.

The buffering control unit 306 checks whether there is free space in the buffer (condition determination step S811). If the result of the condition determination step S811 is “YES”, the buffering control unit 306 transfers the block image data corresponding to the i-th element of the priority table from the image data storage unit 302 to the image data buffer unit 303 (step S812).

Then the buffering control unit 306 increases the value of the variable i by 1 (step S813), and checks whether the value of the variable i is less than a number of the elements of the priority table (condition determination step S814). If the result of the condition determination step S814 is “YES”, processing returns to step S811 to continue buffer content update processing. If the result of the condition determination step S814 is “NO”, this means that no block image data to be buffered remains, and the buffer content update processing is terminated. The case when the result of the condition determination step S811 is “NO” indicates the state that image data can no longer be stored in the buffer, therefore the buffer content update processing is terminated.

The above is a detailed description of FIG. 8. For the buffer content update processing steps S606, S615 and S710, another processing that is different from the processing shown in FIG. 8 may be used, such as completely deleting the content in the buffer, and sequentially reading into the buffer the block image data group having a higher buffering priority.

(Example of Buffering)

Now how block image data is stored in the image data buffer unit 303 when the processing operations in FIG. 6 to FIG. 8 are executed will be described using an example.

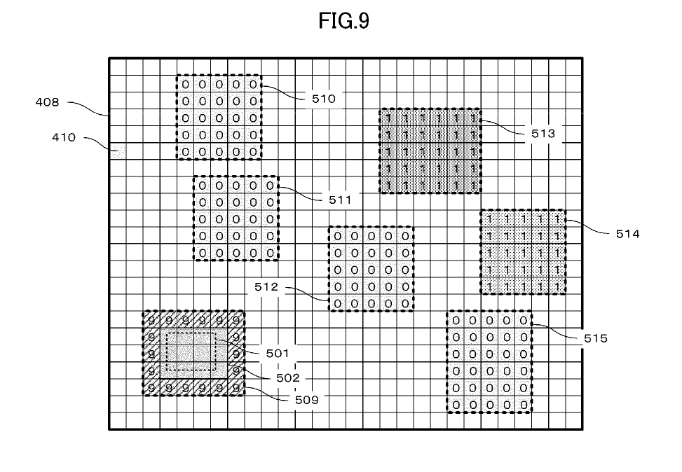

It is assumed that there is a block image data group of which buffering priority shown in FIG. 9 is set in the buffering target areas 509 to 515, for example. FIG. 9 shows a state when annotations of which the creator is “Sakota” are searched in the annotation data in Table 1, and “1” is set for the priority of the block image data belonging to the buffering target areas 513 and 514 related to these searched annotations. For the block image data belonging to the buffering target area 509, that is, the block image data corresponding to the peripheral area of the portion displayed on the image viewer, priority “9”, which is higher than the priority of any other buffering target area, is set. In this embodiment, the priority is set based on the following assumption. That is, when the screen display area 501 moves, it is more likely to be moved by scrolling in the vertical and horizontal directions, rather than by jumping to a distant area, such as an area around the buffering target area 513. As consequence, the priority for executing buffering is higher in the block image data belonging to the buffering target area 509 than the block image data belonging to the buffering target areas 513 and 514. The priority of the block image data belonging to the buffering target area 509 may be set to a number other than “9”, only if this priority is higher than that of the block image data belonging to the buffering target areas 513 and 514.

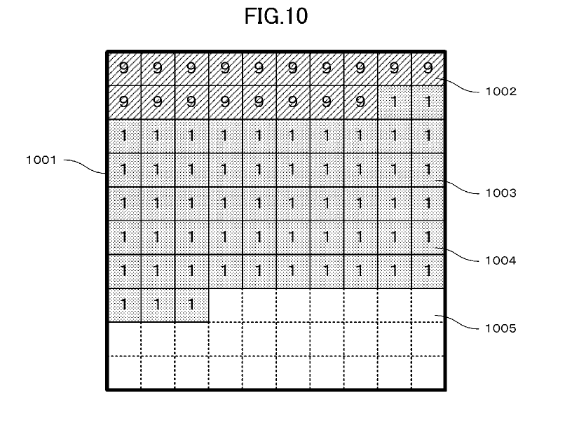

FIG. 10 shows an example of storing the block image data group to a buffer when the above priority is set. 1001 shows the buffer area. In the state shown in FIG. 10, the size of the buffer area 1001 is larger than the total area of the block image data to be buffered, hence free space 1005 is generated even if all the block image data is stored in the buffer. For the storing sequence to the buffer, the block image data group 1002 having the highest buffering priority is stored first, then the block image data groups 1003 and 1004 are stored.

The block image data to be stored in the buffer can either be compressed data or uncompressed data. If the focus is more on increasing the speed of the display processing, it is preferable to decompress the compressed data during program wait time, and store the decompressed data in the buffer in advance. If the focus is more on decreasing the buffer memory capacity, it is preferable to store data in the compressed state.

In this embodiment, the buffering priority is set using only one attribute information, that is, creator, but analysis may be performed combining a plurality of attributes information. For example, a plurality of creators may be specified, or creator information, date information, annotation type information and the like may be specified. To combine a plurality of attributes information, this information may be combined by an AND condition or by an OR condition.

By this embodiment, image data can be buffered at better memory utilization efficiency according to the characteristics of the pathological diagnosis, compared with prior arts, and display responsiveness on the image viewer improves as a result. In concrete terms, the annotation data attached to the pathological image is analyzed, and a higher buffering priority is assigned to the image data around an annotation of which significance for the user is estimated as high, whereby buffering processing, of which memory utilization efficiency is higher than prior arts, becomes possible.

### Embodiment 2

Embodiment 2 of the present invention will now be described with reference to the drawings.

The system configuration, hardware configuration, functional blocks and processing algorithms are the same as Embodiment 1, but the annotation analysis condition and the image data buffering method are different.

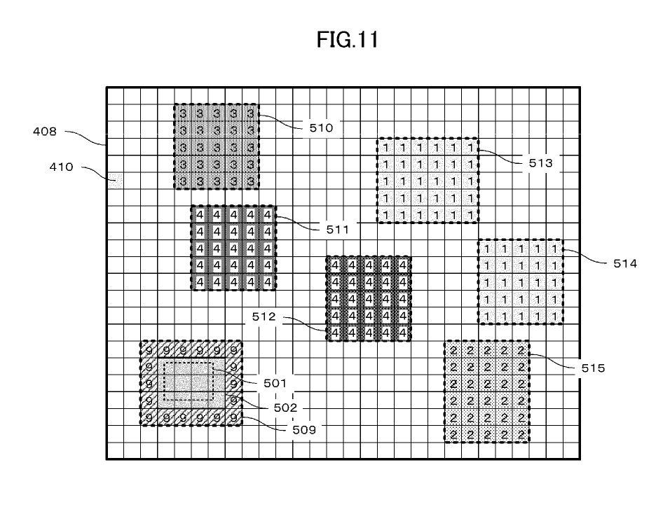

In this embodiment, the annotation data in Table 1 is analyzed, and a higher buffering priority is set to the image data around an annotation of which the last update date is the most recent. FIG. 11 shows a schematic diagram of a state where the buffering priority is set according to this method. In FIG. 11, priority “4” is set to the block image data belonging to the buffering target areas 511 and 512, and priority “3” is set to the block image data belonging to the buffering target area 510. Further, priority “2” is set to the block image data belonging to the buffering target area 515, and priority “1” is set to the block image data belonging to the buffering target areas 513 and 514. In this embodiment as well as in Embodiment 1, it is assumed that when the screen display area 501 moves, that area is more likely to be moved by scrolling in the vertical or horizontal directions rather than jumping to a distant area. Therefore priority “9” is set to the block image data belonging to the buffering target area 509. The priority of the block image data belonging to the buffering target area 509 may be set to a number other than “9” only if this priority is higher than that of the block image data belonging to the other buffering target areas 510 to 515.

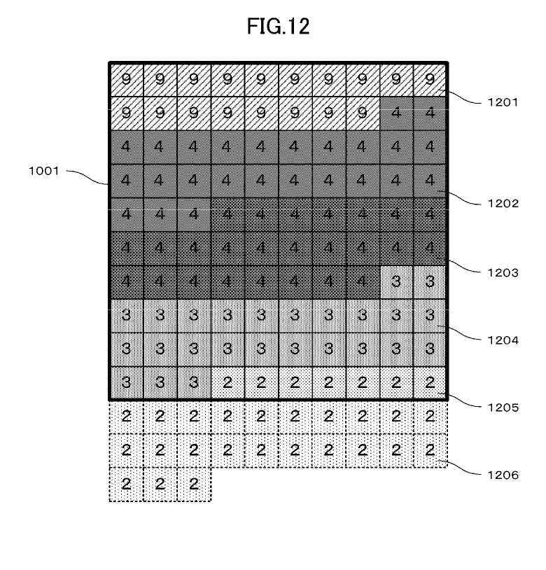

FIG. 12 shows an example of storing the block image data groups in the buffer when the above priorities are set. In the state shown in FIG. 12, the size of the buffer area 1001 is smaller than the total of the block image data to be buffered, hence all the block image data cannot be stored in the buffer. Therefore in this case, buffering is performed in the sequence of: block image data groups 1201, 1202, 1203, 1204 and 1205. The block image data groups 1205 and 1206 are both data belonging to the buffering target area 515, but only the block image data group 1205 is actually buffered, since the size of the buffer area 1001 is limited.

By the buffering control of this embodiment, buffering processing of which memory utilization efficiency is even better than the prior arts and the method of Embodiment 1 can be implemented. In concrete terms, the image data around an annotation having high priority can be buffered according to the size of the buffer area. In particular, the effect is even more clearly demonstrated when a number of annotations linked to the pathological image is very large.

### Embodiment 3

Embodiment 3 of the present invention will now be described with reference to the drawings.

The system configuration, hardware configuration, functional blocks and processing algorithms are the same as Embodiment 1 and Embodiment 2, but the annotation analysis method and image data buffering method are different.

In Embodiment 1 and Embodiment 2, the annotation is analyzed using such attribute information as creator of annotation and last update date, but in this embodiment, the annotation is analyzed using comment information.

Table 3 shows the annotation data used for this embodiment. The annotation data in Table 3 is the same as the annotation date in Table 1, but comment content is more detailed in Table 3.

TABLE 3

| ID | Creator | Comment |
|---|---|---|
| 1 | Takeshita | . . . and fat deposition to liver cells recognized. |
| 2 | Kimura | . . . tumor with clear boundary recognized, also . . . |
| 3 | Kano | . . .epithelial cells cover lamina propria |
| 4 | Sakota | Neutrophilic infiltration is recognized among liver cells |
| 5 | Sakota | . . . very little inflammation, and fibrillization is not |
| | | observed |
| 6 | Kano | . . . no fat deposition recognized in liver cells |

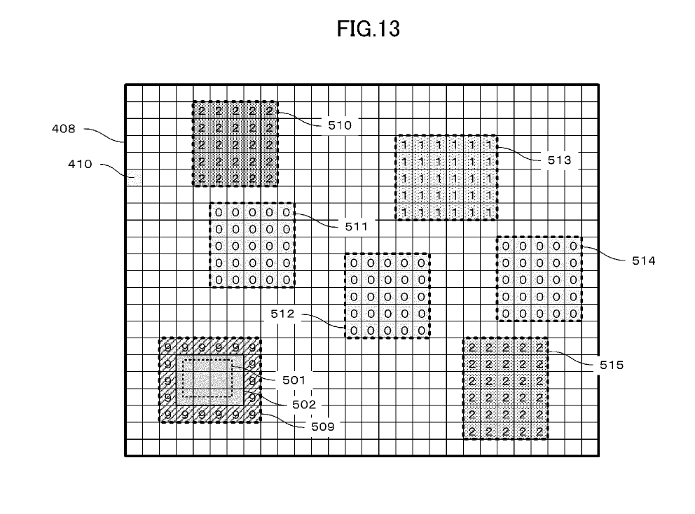

In this embodiment, comments in Table 3 is analyzed, and a higher buffering priority is set to the image data around an annotation that includes the phrase “liver cells” or “fat deposition” under comment. Further, a higher priority is assigned to an annotation which includes both of these phrases over an annotation which includes only one of these phrases. FIG. 13 shows a schematic diagram of a state where the buffering priority is set according to this method. In FIG. 13, priority “2” is set to the block image data belonging to the buffering target areas 510 to 515, and priority “1” is set to the block image data belonging to the buffering target area 513. In this embodiment as well as in Embodiment 1 and Embodiment 2, priority “9” is set to the block image data belonging to the buffering target area 509.

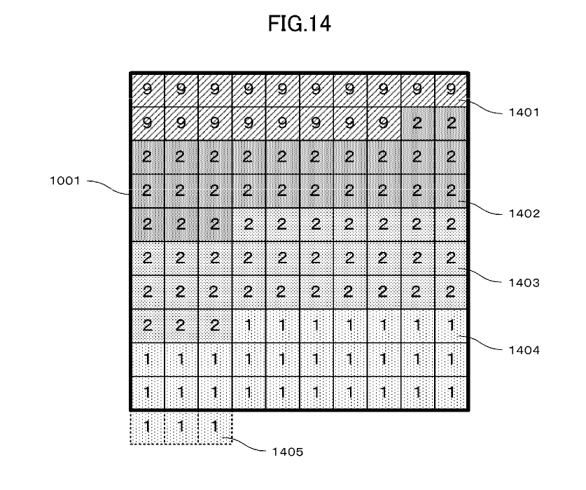

FIG. 14 shows an example of storing the block image data groups to the buffer when the above priorities are set. Just like Embodiment 2, in the state shown in FIG. 14, the size of the buffer area 1001 is smaller than the total of the block image data to be buffered, hence all the block image data cannot be stored in the buffer. Therefore in this case, buffering is performed in the sequence of: block image data groups 1401, 1402, 1403 and 1404. The block image data groups 1404 and 1405 are both data belonging to the buffering target area 513, but only the block image data group 1404 is actually buffered, since the size of the buffer area 1001 is limited.

In this embodiment, buffering priority is set using only the comment information in the annotation, but the comment information and attribute information may be combined to perform analysis. A plurality of attribute information may be combined.

By buffering control of this embodiment, buffering processing of which memory utilization efficiency is even better than the prior arts, and the methods of Embodiment 1 and Embodiment 2, can be implemented. In concrete terms, the buffering is performed using remark information written in a comment of an annotation, whereby the image data around the annotation which is most likely to be referred to can be buffered. In particular, the effect is even more clearly demonstrated when a number of annotations linked to the pathological image is very large.

<Other System Configurations>

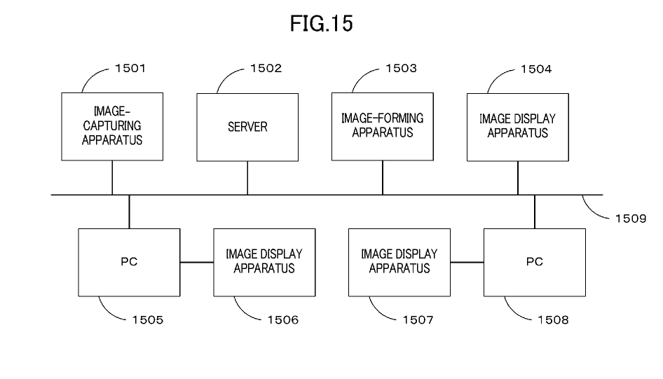

In Embodiment 1 to Embodiment 3, the image processing system is constituted by the image-capturing apparatus, the image-forming apparatus and the image display apparatus as shown in FIG. 1, but the system configuration is not limited to this. For example, as shown in FIG. 15, a plurality of apparatuses may be connected via a network. 1501 is an image-capturing apparatus which primarily corresponds to the image-capturing portion in the virtual slide system. 1502 is a server, which is a large capacity storage (image server) device storing image data, which was captured or generated by 1501. 1503 is an image-forming apparatus, which is a major component to implement the method shown in this embodiment, which reads and processes the image data stored in 1502. 1504 is an image display apparatus, and receives the image data processed by 1503, and displays the image data on screen. 1505 and 1508 are general purpose PCs (personal computers) connected to the network, and 1506 and 1507 are image display apparatuses connected to a PC(s). 1509 is a network line over which various data are exchanged. In this system configuration as well, display responsiveness in each image display apparatus can be improved by executing the buffering control described in Embodiment 1 to Embodiment 3.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium). Therefore, the computer (including the device such as a CPU or MPU), the method, the program (including a program code and a program product), and the non-transitory computer-readable medium recording the program are all included within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-230366, filed on Nov. 6, 2013 and Japanese Patent Application No. 2014-100828, filed on May 14, 2014, which are hereby incorporated by reference herein in their entirety.

What is claimed is:

1. An image data-forming apparatus that generates display image data from pathological image data, the display image data being generated for a viewer having a function of displaying a part of a pathological image and changing the display target part according to an operation by a user,
the image data-forming apparatus comprising:
an image data buffer unit that can temporarily store a part of the pathological image data;
an image data output unit that generates display image data from the pathological image data, and that uses data stored in the image data buffer unit when data required for generating the display image data is stored in the image data buffer unit; and
a buffering control unit that implements control of storing data on a part of the pathological image in the image data buffer unit, wherein
the pathological image data includes data on a plurality of annotations attached to certain positions in the pathological image, and
the buffering control unit controls buffering based on information on the pathological diagnosis linked to each of the plurality of annotations.

2. The image-data forming apparatus according to claim 1, further comprising an annotation information analysis unit that extracts an annotation that matches with an analysis condition provided by analyzing information on the pathological diagnosis, wherein
priority among the plurality of annotations for buffering can be determined based on an analysis result by the annotation information analysis unit.

3. The image data-forming apparatus according to claim 2, wherein
the analysis condition includes at least one of an annotation creator, a date or date and time when the annotation is created or updated, and a keyword included in the information on the pathological diagnosis linked to the annotation.

4. The image data-forming apparatus according to claim 2, wherein
the buffering control unit updates the data stored in the image data buffer unit when the analysis condition is changed.

5. The image data-forming apparatus according to claim 1, wherein
the buffering control unit controls the buffering so that the data corresponding to a peripheral area of a display area which is displayed on the viewer is preferentially stored in the image data buffer unit, over the data corresponding to the portion where an annotation is attached.

6. The image data-forming apparatus according to claim 1, wherein
the entire pathological image data is divided into a plurality of blocks of image data, and
the buffering to the image data buffer unit is controlled in block units.

7. The image data-forming apparatus according to claim 1, wherein
the pathological image data includes image data having different depths, and
the buffering control unit controls the buffering such that not only the data on a portion with an annotation in an image data having a same depth as the display image that is displayed on the viewer, but also data on a corresponding portion in the image data of which depth is different from that of the display image, is stored in the image data buffer unit.

8. The image data-forming apparatus according to claim 1, wherein
the data on the pathological image includes image data of different magnifications, and
the buffering control unit controls the buffering such that not only the data on a portion with an annotation in an image data having a same magnification as the display image that is displayed on the viewer, but also data on a corresponding portion in the image data of which magnification is different from that of the display image, is stored in the image data buffer unit.

9. An image data-forming method comprising:
an image data buffer step of temporarily storing a part of the pathological image data in an image data buffer unit;
an image data output step of generating display image data from the pathological image data for a viewer having a function of displaying a part of the pathological image and changing the display target part according to an operation by the user, and using the data stored in the image data buffer unit when the data required for generating the display image data is stored in the image data buffer unit;
a step of acquiring data on a plurality of annotations, included in the pathological image data and attached to certain positions in the pathological image; and
a step of implementing control of storing a part of the pathological image in the image data buffer unit based on the information on the pathological diagnosis linked to each of the plurality of annotations.

10. A non-transitory computer readable storage medium storing a program that causes an image data-forming apparatus to be executing:
an image data buffer step of temporarily storing a part of the pathological image data in an image data buffer unit;
an image data output step of generating display image data from the pathological image data for a viewer having a function of displaying a part of the pathological image and changing the display target part according to an operation by the user, and using the data stored in the image data buffer unit when the data required for generating the display image data is stored in the image data buffer unit;
a step of acquiring data on a plurality of annotations, included in the pathological image data and attached to certain positions in the pathological image; and
a step of implementing control of storing a part of the pathological image in the image data buffer unit based on the information on the pathological diagnosis linked to each of the plurality of annotations.
